(19) United States
(12) Patent Application Publication
(10) Pub. No.: US 2025/0186916 A1
(43) Pub. Date: Jun. 12, 2025

(54) METHOD FOR REMOVING ENTRAINED LIQUID DROPLETS FROM A CRYOGENIC GAS

(71) Applicants: Air Liquide Large Industries U.S. LP, Houston, TX (US); L'Air Liquide, Société Anonyme pour l'Etude et l'Exploitation des Procédés Georges Claude, Paris (FR)

(72) Inventors: Gary D. MILLER, Houston, TX (US); Joshua Light, Houston, TX (US)

(21) Appl. No.: 18/530,512

(22) Filed: Dec. 6, 2023

(51) Int. Cl. B01D 45/16; B01D 45/18; F25J 3/06

(52) U.S. Cl. CPC B01D 45/16; B01D 45/18; F25J 3/0655

(57) ABSTRACT

A method for removing entrained liquid droplets from a gas is provided. The method includes introducing a gas with entrained liquid droplets into a cyclone separator, thereby producing a gaseous portion and a liquid portion. Wherein the gaseous portion exits the cyclone separator, and wherein the liquid portion is restricted by a liquid control valve and collected in a reservoir volume in the cyclone separator. The method also includes opening the liquid control valve upon receiving a signal from a liquid level sensor located in the reservoir volume, the liquid portion thereby exiting the cyclone separator.

### BACKGROUND

Once produced, cryogenic vapor will tend to form liquid droplets as heat transfers from the cold vapor to the warm ambient environment. These entrained liquid droplets may cause problems with downstream equipment such as compressors. A chevron-type separator may be used to remove these entrained liquid droplets but can be overwhelmed if there is too much liquid and therefore allowing destructive liquid to pass-through. This can also be a significant problem with non-cryogenic fluids as well. There is a need in the industry for an improved method for removing entrained liquid droplets from a cryogenic vapor stream.

### SUMMARY

A method for removing entrained liquid droplets from a cryogenic gas is provided. The method includes introducing a gas with entrained liquid droplets into a cyclone separator, thereby producing a gaseous portion and a liquid portion, wherein the gaseous portion exits the cyclone separator, and wherein the liquid portion is restricted by a liquid control valve and collected in a reservoir volume in the cyclone separator. The method also includes opening the liquid control valve upon receiving a signal from a liquid level sensor located in the reservoir volume, after which the liquid portion exits the cyclone separator.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a liquid removal system, in accordance with one embodiment of the present invention.

FIG. 2a is another schematic representation of a liquid removal system, in accordance with one embodiment of the present invention.

FIG. 2b is another schematic representation of a liquid removal system, in accordance with one embodiment of the present invention.

FIG. 3 is another schematic representation of a liquid removal system, in accordance with one embodiment of the present invention.

### ELEMENT NUMBERS

101=feed stream
102=cyclone separator
103=vacuum insulation volume
104=vapor stream
105=liquid stream
106=barrel (of the cyclone separator)
107=cone (of the cyclone separator)
201=liquid volume
202=liquid level sensor
203=liquid control valve
204=liquid level signal
301=first vapor stream
302=first liquid stream
303=liquid vapor separator (chevron-type)
304=chevron separator
305=second vapor stream
306=second liquid stream

### DETAILED DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

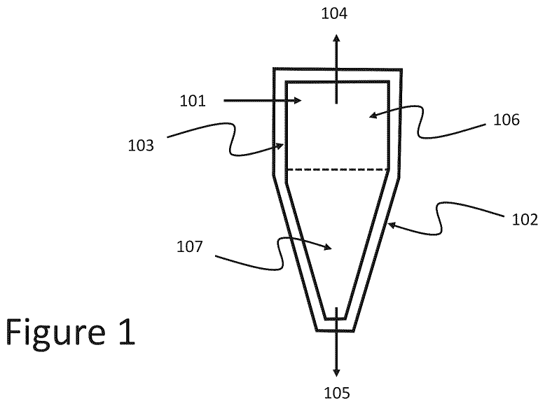

Turning to FIG. 1, a liquid removal system, in accordance with one embodiment of the present invention, is provided. Feed stream 101 is a fluid stream that contains droplets of entrained liquid. Feed stream 101 may be any fluid stream that contains droplets of entrained liquid. Feed stream 101 is introduced into cyclone separator 102, thereby producing vapor stream 104 and liquid stream 105. Cyclone separator 102 may include a vacuum insulation volume 103.

Cyclone separator 102 may be of any design known in the art that is configured to separate small droplets of entrained liquid from a vapor stream. As indicated in FIG. 1, internally the cyclone separator is made up of two main regions: barrel 106 and cone 107. The fluid that is to be separated is introduced into barrel 106 at high velocity. The fluid spirals within barrel 106 in a descending helical pattern. The centrifugal forces separate the higher density liquid from the lower density gas. The higher density liquid collects along the inner wall of barrel 106 and descends. As the spiraling fluid continues to descend within cyclone separator 102, at least a portion will enter cone 107. As this fluid descends further, it accelerates, thus more aggressively separating the liquid from the gas. The separated gas then travels upward through the helically spinning gas and exits as vapor stream 104. The liquid that has been making its way down the inner wall of barrel 106 and cone 107 eventually exits as liquid stream 105.

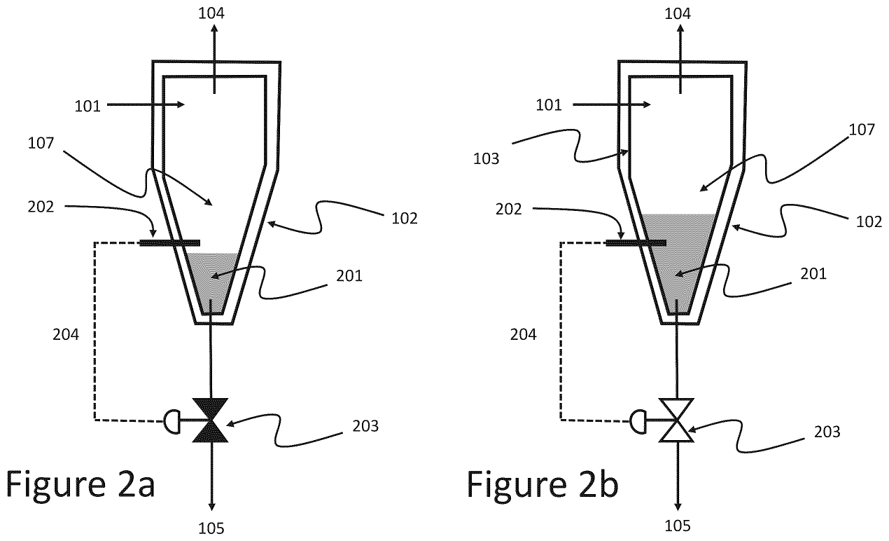

Turning to FIG. 2a and FIG. 2b, a liquid removal system, in accordance with another embodiment of the present invention, is provided. Feed stream 101 is a fluid stream that contains droplets of entrained liquid. Feed stream 101 is introduced into cyclone separator 102, thereby producing vapor stream 104 and liquid stream 105. Cyclone separator 102 may include a vacuum insulation volume 103. Cyclone separator 102 may be of any design known in the art that is configured to separate small droplets of entrained liquid from a vapor stream.

Cyclone separator 102 also includes a reservoir area in cone 107, with liquid level sensor 202 which is configured to sense the presence of liquid volume 201. Liquid level sensor 202 sends liquid level signal 204 to liquid control valve 203. As indicated in FIG. 2a, as long as the level of liquid volume 201 remains below a predetermined level as measured by liquid level sensor 202, liquid control valve 203 remains closed. As indicated in FIG. 2b, as the level of liquid volume 201 exceeds the predetermined level as measured by liquid level sensor 202, liquid control valve 203 opens, thus allowing liquid 201 to leave the system as liquid stream 105.

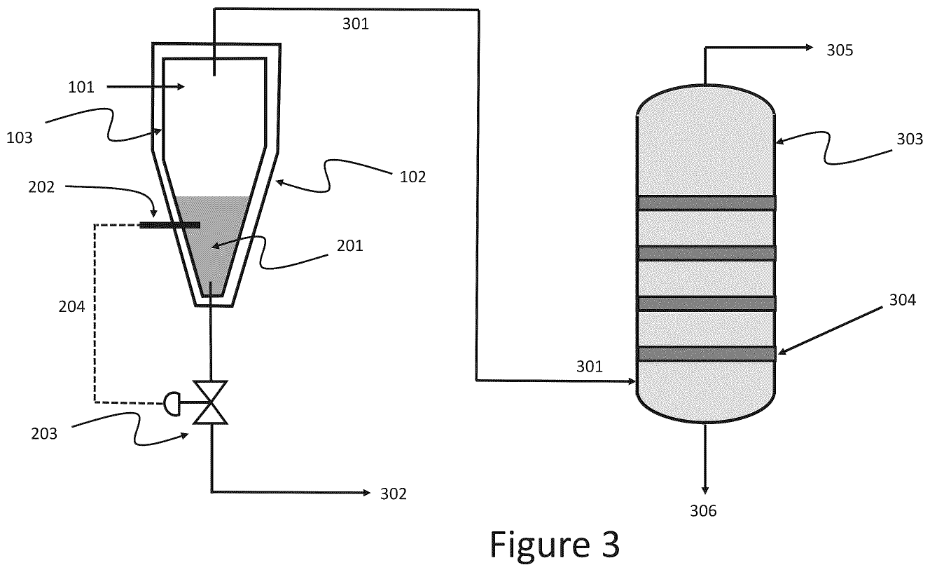

Turning to FIG. 3, a liquid removal system, in accordance with yet another embodiment of the present invention, is provided. Feed stream 101 is a fluid stream that contains droplets of entrained liquid. Feed stream 101 is introduced into cyclone separator 102, thereby producing first vapor stream 301 and first liquid stream 302. Cyclone separator 102 may include a vacuum insulation volume 103. Cyclone separator 102 may be of any design known in the art that is configured to separate small droplets of entrained liquid from a vapor stream.

Cyclone separator 102 also includes liquid level sensor 202 which is configured to sense the presence of liquid volume 201. Liquid level sensor 202 sends liquid level signal 204 to liquid control valve 203. As in the previous embodiment, as long as the level of liquid volume 201 remains below a predetermined level as measured by liquid level sensor 202, liquid control valve 203 remains closed. Then, as the level of liquid volume 201 exceeds the predetermined level as measured by liquid level sensor 202, liquid control valve 203 opens, thus allowing first liquid stream 302 to leave the system.

First vapor stream 301 then enters liquid vapor separator 303, thereby producing second vapor stream 305 and second liquid stream 306. Liquid vapor separator 303 may contain chevron separators 304 to separate the liquid phase from the vapor phase. Liquid vapor separator 303 may be of any design known in the art. First liquid stream 302 and second liquid stream 306 may exit the system separately. Second vapor stream 305 exits the system.

The combination of cyclone separator 102 and chevron-base separator 303 allows a two-stage separation process. Cyclone separator 102 will remove a considerable amount of the liquid present in feed stream 101, thus “unloading” chevron-base separator 303. This arrangement is especially advantageous if slugs of liquid may typically enter the separation system. Cyclone separator 102 thus offers a potentially critical layer of protection for the overall system. This is especially critical if the downstream system has a low tolerance for entrained liquid droplets in the gas phase.

The above system will work on any fluid stream that contains droplets of entrained liquid. In a preferred embodiment, the fluid is cryogenic. In a more preferred embodiment, the fluid is hydrogen. The non-limiting example described below uses two-phase hydrogen, but the steps and phases described are applicable to any appropriate fluid.

Turning again to FIG. 1, a liquid removal system, in accordance with another embodiment of the present invention, is provided. Cryogenic feed stream 101 is a cryogenic fluid stream that contains droplets of entrained cryogenic liquid. Cryogenic feed stream 101 is introduced into cyclone separator 102, thereby producing cryogenic vapor stream 104 and cryogenic liquid stream 105. Cyclone separator 102 may include a vacuum insulation volume 103.

The above system will work on any fluid stream that contains droplets of entrained liquid. In a preferred embodiment, the fluid is cryogenic. In a more preferred embodiment, the fluid is hydrogen. The non-limiting example described below uses two-phase hydrogen, but the steps and phases described are applicable to any appropriate cryogenic fluid.

Cyclone separator 102 may be of any design known in the art that is configured to separate small droplets of entrained liquid from a vapor stream. As indicated in FIG. 1, internally the cyclone separator is made up of two main regions: barrel 106 and cone 107. The cryogenic fluid that is to be separated is introduced into barrel 106 at high velocity. The cryogenic fluid spirals within barrel 106 in a descending helical pattern. The centrifugal forces separate the higher density liquid from the lower density gas. The higher density liquid collects along the inner wall of barrel 106 and descends. As the spiraling cryogenic fluid continues to descend within cyclone separator 102, at least a portion will enter cone 107. As this cryogenic fluid descends further, it accelerates, thus more aggressively separating the liquid from the gas. The separated gas then travels upward through the helically spinning gas and exits as cryogenic vapor stream 104. The liquid that has been making its way down the inner wall of barrel 106 and cone 107 eventually exits as cryogenic liquid stream 105.

Turning to FIG. 2a and FIG. 2b, a cryogenic liquid removal system, in accordance with another embodiment of the present invention, is provided. Cryogenic feed stream 101 is a cryogenic fluid stream that contains droplets of entrained cryogenic liquid. Cryogenic feed stream 101 may be cryogenic hydrogen. Cryogenic feed stream 101 is introduced into cyclone separator 102, thereby producing cryogenic vapor stream 104 and cryogenic liquid stream 105. Cyclone separator 102 may include a vacuum insulation volume 103. Cyclone separator 102 may be of any design known in the art that is configured to separate small droplets of entrained liquid from a vapor stream.

Cyclone separator 102 also includes a reservoir area in cone 107, with liquid level sensor 202 which is configured to sense the presence of cryogenic liquid volume 201. Liquid level sensor 202 sends liquid level signal 204 to liquid control valve 203. As indicated in FIG. 2a, as long as the level of cryogenic liquid volume 201 remains below a predetermined level as measured by liquid level sensor 202, liquid control valve 203 remains closed. As indicated in FIG. 2b, as the level of cryogenic liquid volume 201 exceeds the predetermined level as measured by liquid level sensor 202, liquid control valve 203 opens, thus allowing cryogenic liquid 201 to leave the system as cryogenic liquid stream 105.

Turning to FIG. 3, a cryogenic liquid removal system, in accordance with yet another embodiment of the present invention, is provided. Cryogenic feed stream 101 is a cryogenic fluid stream that contains droplets of entrained cryogenic liquid. Cryogenic feed stream 101 may be cryogenic hydrogen. Cryogenic feed stream 101 is introduced into cyclone separator 102, thereby producing first cryogenic vapor stream 301 and first cryogenic liquid stream 302. Cyclone separator 102 may include a vacuum insulation volume 103. Cyclone separator 102 may be of any design known in the art that is configured to separate small droplets of entrained liquid from a vapor stream.

Cyclone separator 102 also includes liquid level sensor 202 which is configured to sense the presence of cryogenic liquid volume 201. Liquid level sensor 202 sends liquid level signal 204 to liquid control valve 203. As in the previous embodiment, as long as the level of cryogenic liquid volume 201 remains below a predetermined level as measured by liquid level sensor 202, liquid control valve 203 remains closed. Then, as the level of cryogenic liquid volume 201 exceeds the predetermined level as measured by liquid level sensor 202, liquid control valve 203 opens, thus allowing first cryogenic liquid stream 302 to leave the system.

First cryogenic vapor stream 301 then enters liquid vapor separator 303, thereby producing second cryogenic vapor stream 305 and second cryogenic liquid stream 306. Liquid vapor separator 303 may contain chevron separators 304 to separate the liquid phase from the vapor phase. Liquid vapor separator 303 may be of any design known in the art. First cryogenic liquid stream 302 and second cryogenic liquid stream 306 may exit the system separately. Second cryogenic vapor stream 305 exits the system.

The combination of cyclone separator 102 and chevron-base separator 303 allows a two-stage separation process. Cyclone separator 102 will remove a considerable amount of the liquid present in cryogenic feed stream 101, thus “unloading” chevron-base separator 303. This arrangement is especially advantageous if slugs of liquid may typically enter the separation system. Cyclone separator 102 thus offers a potentially critical layer of protection for the overall system. This is especially critical if the downstream system has a low tolerance for entrained liquid droplets in the gas phase.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for removing entrained liquid droplets from a gas, comprising:
a) introducing a gas with entrained liquid droplets into a cyclone separator, thereby producing a gaseous portion and a liquid portion,
wherein the gaseous portion exits the cyclone separator,
wherein the liquid portion is restricted by a liquid control valve and collected in a reservoir volume in the cyclone separator,
b) opening the liquid control valve upon receiving a signal from a liquid level sensor located in the reservoir volume, the liquid portion thereby exiting the cyclone separator.

2. The method of claim 1, wherein the gas with entrained liquid droplets is cryogenic.

3. The method of claim 1, wherein the gas with entrained liquid droplets is hydrogen.

4. The method of claim 1, wherein the cyclone separator comprises a vacuum insulated volume.

5. The method of claim 1, further comprising:
c) introducing the vapor portion exiting the cyclone separator into a chevron-type liquid-vapor separator, thereby producing a secondary gaseous portion and a secondary liquid portion.
